(19) United States
(12) Patent Application Publication
(10) Pub. No.: US 2007/0171932 A1
(43) Pub. Date: Jul. 26, 2007

(54) System and method for dynamic allocation and routing of resources

(75) Inventors: Sibnath Basuthakur, Phoenix, AZ (US); David Paldan, Scottsdale, AZ (US); Jim Miller, Phoenix, AZ (US); Patrick Armstrong, Scottsdale, AZ (US); Myron Wagner, Gilbert, AZ (US)

Correspondence Address: INGRASSIA FISHER & LORENZ, P.C., 7150 E. CAMELBACK, STE. 325, SCOTTSDALE, AZ, 85251, US

(73) Assignee: General Dynamics C4 Systems, Inc.

(21) Appl. No.: 11/336,592

(22) Filed: Jan. 20, 2006

(51) Int. Cl. H04B 7/212

(52) U.S. Cl. 370/442

(57) ABSTRACT

Systems and methods are provided for dynamically allocating and routing resource in a wireless communication system. The system includes at least one scheduled resource, a first terminal having a resource requirement and configured to acquire an alternate resource in response to an out-of-band signal, and a controller. The controller is configured to determine the alternate resource from the scheduled resource, schedule the alternate resource for the first terminal based on the resource requirement, and direct the first terminal to a set of frequencies of the alternate resource via the out-of-band signal The method includes determining an alternate resource in the wireless communication system from scheduled resource uses, scheduling the alternate resource for a terminal based on a scheduled resource use of the terminal, and directing the terminal to acquire the alternate resource at a set of frequencies of the alternate resource.

### FIELD OF THE INVENTION

The present invention generally relates to wireless communications, and more particularly relates to system and methods for managing available capacity in a wireless communication system.

### BACKGROUND OF THE INVENTION

Wireless communication systems have been implemented in numerous applications such as worldwide television, communication to remote areas, wide area data networks, global personal communications to hand-held portable telephones, broadband voice, video, and data. Satellite transponders may be used to facilitate communication for each of these applications. In one example of a wireless communication system, a satellite transponder provides about thirty-six (36) MHz of bandwidth for communication in a particular frequency band and using a particular carrier, and each satellite may have about forty (40) transponders. The satellite transponders thus provide a resource or capacity that may be leased for use based at least in part on a particular frequency. This resource may also be leased based on a time period (e.g., every weekday for a one hour time period beginning at seven (7) a.m.). The communication resource may also be leased based on an available radio frequency (RF) power that is limited by the finite amount of RF power available on the particular transponder. Typically, the amount of power is proportional to the leased frequency, but more or less power may be leased for a specific frequency.

The resource is typically leased in advance for large blocks of time, such as twenty-four hours per day and for every day of the year. In general, the longer the lease or the more capacity that is leased, the better the lease rate. For example, the capacity of a particular transponder on a particular satellite may be leased to a single subscriber each day of the year. This resource may be further subdivided (e.g., into multiple time slots for a twenty-four (24) hour period) and leased by the single subscriber to other users who in turn may further subdivide the leased portions of spectrum. In the event that the subscriber cannot access the transponder associated with a particular leased capacity (e.g., by being out-of range of the transponder associated with the particular leased capacity or during transponder or satellite failure), and thus does not use some portion of the leased capacity, the subscriber may have to lease additional (e.g., in addition to the original leased capacity) capacity from a different transponder and/or a different satellite.

In most instances, the leased capacity exceeds the actual capacity used by the subscriber and results in idle time slots or unused capacity. In general, the subscriber leases, in advance, the transponder capacity based on a peak capacity demand of the subscriber and an associated margin. At various times, such as lower capacity demand, the subscriber typically does not use a portion of the leased capacity. Additionally, the subscriber may purchase a greater amount of leased capacity to obtain a lower purchase rate. Although the subscriber obtains the lower purchase rate, the subscriber has leased extra capacity that generally goes unused by the subscriber.

In view of the foregoing, it is desirable to provide a communication system that more efficiently manages transponder capacity use. More particularly, it is desirable to provide a communication system that more efficiently manages transponder capacity use for a variety of operating parameters. In addition, it is desirable to provide a method for more efficiently allocating transponder capacity to subscribers in a communication system. Furthermore, other desirable features and characteristics of the present invention will become apparent from the subsequent detailed description and the appended claims, taken in conjunction with the accompanying drawings and this background of the invention.

### BRIEF SUMMARY

Systems and methods are provided for dynamically allocating and routing resources to one or more terminals in a wireless communication system. In one exemplary embodiment, a method for resource allocation in a wireless communication system having out-of-band communication with one or more terminals is provided. The one or more terminals each have a scheduled resource use in the wireless communication system. The method comprises the steps of determining an alternate resource in the wireless communication system, scheduling the alternate resource for one of the terminals based on the scheduled resource use of the terminal, and directing the terminal to acquire the alternate resource at a set of frequencies of the alternate resource.

In another exemplary embodiment, a radio communication system for allocating resources to one or more terminals is provided. The radio communication system comprises at least one scheduled resource, a first terminal selected from the one or more terminals having a resource requirement and configured to acquire an alternate resource in response to an out-of-band command, and a controller configured to determine the alternate resource from the at least one scheduled resource, schedule the alternate resource for the first terminal based on the resource requirement, and direct the first terminal to the alternate resource at a set of frequencies of the alternate resource via the out-of-band command.

In yet another exemplary embodiment, a method for allocating a partitionable transponder capacity in a wireless communication system having one or more terminals and one or more transponders is provided. The method comprises determining an alternate capacity of a first transponder of the one or more transponders from the partitionable transponder capacity, scheduling the alternate capacity for a first terminal of the one or more terminals based on a scheduled transponder use of the first terminal and directing the first terminal to acquire the first transponder at a set of frequencies of the alternate capacity.

### BRIEF DESCRIPTION OF THE DRAWINGS

The present invention will hereinafter be described in conjunction with the following drawing figures, wherein like numerals denote like elements, and

FIG. 1 is a block diagram of a communication system in accordance with an exemplary embodiment of the present invention;

FIG. 2 is a block diagram of a terminal in accordance with an exemplary embodiment;

FIG. 3 illustrates resource allocation in the communication system in accordance with an exemplary embodiment; and

FIG. 4 is a flow diagram of a method for allocating resources in a communication system in accordance with an exemplary embodiment of the present invention.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the drawings.

A communication system and a method are provided for allocating and routing transponder capacity to one or more terminals in the communication system. Although the communication system and method allocate and route transponder capacity, the communication system and method may allocate and route other partitionable resources to the terminals. Generally, the communication system includes, but is not limited to, one or more service providers, a central controller communicating with each of the one or more service providers, and one or more terminals communicating with the central controller. Each of the service providers has a scheduled resource (e.g., a time, duration, channel, and the like for using a specific transponder). The central controller acquires the corresponding scheduled resources for each of the service providers. From the scheduled resources, the central controller may dynamically schedule resource use and/or switch satellites or transponder channels for a number of different operating parameters including, but not necessarily limited to, bandwidth, quality of service requirement and usage, access time of day, access priority and message delay requirement, satellite band and the corresponding satellite footprint, service contract length and other service level agreements, and lower cost of service.

The communication system and subsequently described apparatus and methods are preferably utilized in a wireless communication system such as a satellite communication system, cellular communication system or other Personal Communication Systems (PCS). However, the principles discussed herein are readily applied to other wireless based, radio, cable television (CATV), telephony as well as other data, voice, or a combination data and voice communications systems. Furthermore, the type of end-user services provided at the terminals of the communication system is not critical and the principles discussed herein are readily applied to systems providing a variety of end-user services.

Referring to FIG. 1, a block diagram of a communication system is shown in accordance with an exemplary embodiment of the present invention. It should be appreciated that the blocks of FIG. 1, as well as the blocks in the other block diagrams disclosed herein, represent functional elements and are not intended to represent discrete hardware elements. The communication system 10 comprises one or more service providers 12, 14, 16 (e.g., service 1, service 2, . . . , service N), a central controller 18 configured to communicate with each of the service providers 12, 14, 16, and one or more terminals 20, 22, 24 (e.g., terminal 1, terminal 2, . . . , terminal N) configured to communicate with the central controller 18. The central controller 18 acquires the scheduled resources for each of the service providers 12, 14, 16 via a pre-existing database containing the scheduled resource and any related updates to the scheduled resource or directly from the service providers 12, 14, 16.

Although the communication system 10 is described with respect to a central controller 18, the functions of the central controller 18 may be distributed throughout the communication system 10 and control processing can occur within one or more of the terminals 20, 22, 24 in the system 10 with explicit communication of resource use (e.g., the active resources report their state) or implicit communication or resource use (e.g., all terminals monitor the active resources, then independently contend for resources). Additionally, control processing can operate outside of the terminals (e.g., on one or more processors) and communicate through one of multiple paths to a terminal via a service or resource. In one example using time division multiple access (TDMA), the central controller 18 assigns frequencies and time slots to the terminals 20, 22, 24. In another example, code division multiple access 2000 (CDMA2000) is initiated by a user terminal, performance is monitored, and changes are made to operation based upon observation of the received data or feedback from a companion terminal. In another example, a CDMA2000 zone controller monitors local activity in its zone and neighboring zones and suggests to the terminal that better service is available elsewhere. In response, the terminal and any companion terminals may choose to transmit to the newly offered service. The allocations associated with these services are typically driven by packing or bit error rate (BER) considerations, although resource allocations may be based on other considerations such as cost, resource use efficiency, function, capability, and the like.

In the communication system 10, the terminals 20, 22, 24 may be stationary or mobile. The central controller 18 communicates with the service providers 12, 14, 16 and the terminals 20, 22, 24 via wireless communication or other communication techniques and includes, but is not necessarily limited to, the corresponding applications and hardware components associated with the particular communication technique. In an exemplary embodiment, the scheduled resources include, but are not necessarily limited to, a transponder use that may be based on at least one of a time slot, a transponder channel, a specific satellite and corresponding transponder, and the like. For example, the service provider 12 (service 1) may have a scheduled resource of a five hour daily time slot between 7 pm and 12 pm on transponder channel F01, transponder 1, satellite 2.

From the scheduled resources, the central controller 18 manages resources (e.g., the use of transponder capacity) in accordance with a variety of operating parameters while fulfilling the actual transponder capacity required by the service providers 12, 14, 16. To manage the resources, the central controller 18 is configured to allocate alternate resources to one or more terminals 20, 22, 24 by modifying pre-existing transponder assignments of the scheduled resources. Unused resources, idle resources, or resources otherwise allocated outside of the pre-existing scheduled resources are referred to as alternate resources. In an exemplary embodiment, the central controller 18 determines any unused or idle resources (e.g., unused transponder capacity) and reassigns the transponders associated with these resources. For example, the central controller 18 may automatically allocate unused or idle resources to a terminal, allocate unused or idle resources in response to a terminal request, or substitute a portion of a scheduled resource to incorporate some or all of the unused or idle resource. In another exemplary embodiment, the central controller 18 may allocate one or more portions of the scheduled resource for a particular terminal to a different terminal to satisfy a particular operating parameter. For example, a first terminal may desire a lower cost of service whenever available from the communication system. In this case, the central controller 18 substitutes a portion of a scheduled resource of a second terminal for a portion of the scheduled resource of the first terminal.

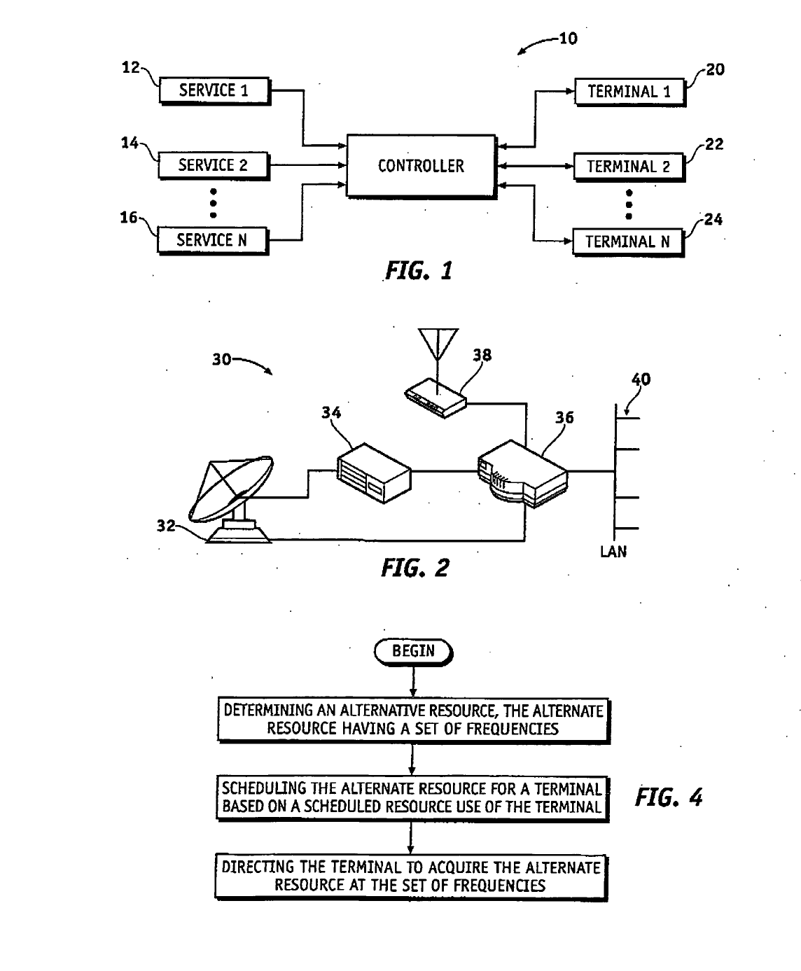

FIG. 2 is a block diagram of a terminal 30, such as the terminal 20 shown in FIG. 1, in accordance with an exemplary embodiment. The terminal 30 comprises an antenna 32 (e.g., a satellite dish), an antenna controller 34 coupled to the antenna 32, a processing unit 36 having an input coupled to the antenna 32 and a first output coupled to the antenna controller 34, and a control channel transceiver 38 coupled to the processing unit 36. Additionally, the terminal 30 may further comprise a network interface (e.g., local area network (LAN) connection) to provide access to subscribers of the services associated with the terminal 30. The terminal 30 is associated with a particular service provider, such as the service providers 12, 14, 16, and has an associated scheduled resource (e.g., use of a transponder). The terminal accesses the scheduled resource via the antenna 32 to provide the service associated with the particular service provider.

In an exemplary embodiment, the antenna 32 is preferably a self-aligning antenna. The antenna controller 34 directs the antenna 32 based on the scheduled resources of the terminal 30 and/or the alternate resources allocated by the central controller 18 to the terminal 30. In an exemplary embodiment, the processing unit 36 communicates out-of-band (e.g., outside of the communication to provide the associated service) via the control channel transceiver 38 with the central controller 18 to receive alternate resource allocation. For example, the terminal 30 receives routing data from the central controller 18 for the allocated alternate resources via the control channel transceiver 38. Additionally, the terminal 30 may transmit a request for an alternate resource via the control channel transceiver 38. The control channel transceiver may be based on a variety of communication techniques including, but not necessarily limited to, out-of-band wireless communication, standard telephony, and the like. Although the terminal 30 is described with respect to out-of-band communication with the central controller 18, the terminal 30 may also communicate with the central controller 18 via in-band communication (e.g., control packets within a data stream).

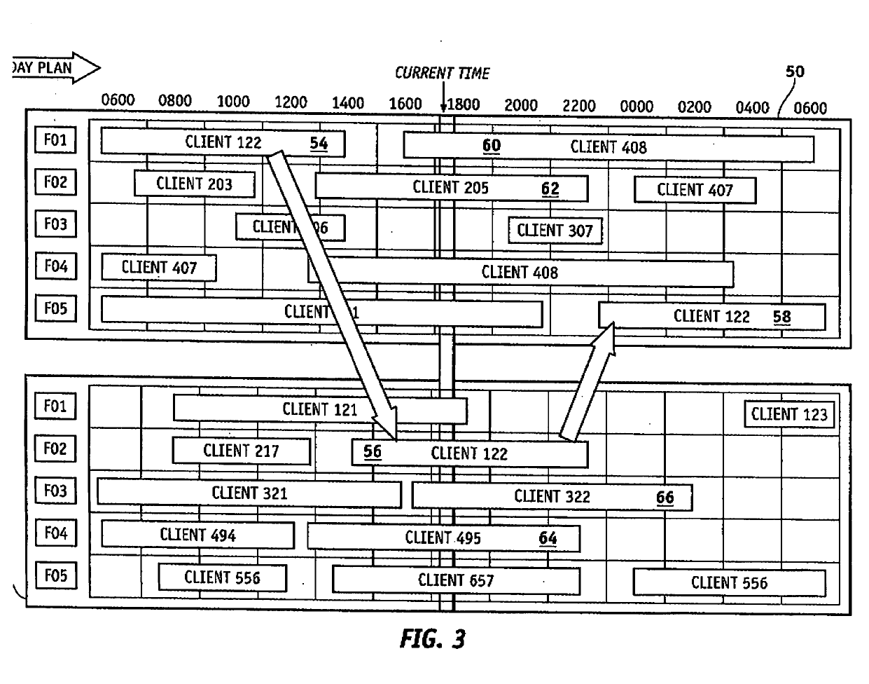

FIG. 3 illustrates resource allocation in the communication system in accordance with an exemplary embodiment. First and second transponder resource allocations 50 and 52 are shown with respect to a twenty-four hour duration and different frequencies. For example, the first transponder resource allocation 50 is based on a first transponder (e.g., transponder 01, satellite 01) having a first set of frequencies (e.g., F01, F02, . . . , F05), and the second transponder resource allocation 52 is based on a second transponder (e.g., transponder 01, satellite 02) having a second set of frequencies (e.g., F01, F02, . . . , F05). Each of the transponder resource allocations 50 and 52 illustrate scheduled resources 60, 62, 64, 66 for different clients (e.g., Client 408, Client 205, Client 495, Client 322, etc.).

In the past, once the transponder resource was scheduled (e.g., leased), in advance, subsequent changes or access to the scheduled resource were unavailable. Using the resource allocation of the communication system 10, alternate resources may be allocated. For example, Client 122 may request transponder use, after the resources have been scheduled, for about a twenty-four hour period (e.g., from about 0600 to about 0600 the subsequent day). In response, central controller 18 determines any alternate resources 54, 45, 58, and allocates a first alternate resource 54, a second alternate resource 56, and a third alternate resource 58 to the terminal providing service to Client 122. In operation, the central controller 18 directs the terminal, providing service to Client 122, to acquire the first transponder (e.g., transponder 01, satellite 01) at frequency F01, then directs the terminal to acquire the second transponder (e.g., transponder 01, satellite 02) at frequency F02, and directs the terminal to acquire the first transponder (e.g., transponder 01, satellite 01) at frequency F05.

FIG. 4 is a flow diagram of a method 100 for allocating resources in a communication system in accordance with an exemplary embodiment of the present invention. An alternate resource in the wireless communication system is determined from the scheduled resources at step 105. The alternate resource has a set of frequencies associated therewith. The alternate resource is scheduled for a terminal in the communication system based on the scheduled resource of the terminal at step 110. In an exemplary embodiment, the alternate resource has an associated available radio frequency (RF) power, and the terminal has an RF power requirement. In this case, the alternate resource is scheduled for the terminal based on the RF power requirement and the available RF power. In another exemplary embodiment, the alternate resource has an associated time slot, and the alternate resource is scheduled for the terminal based on the scheduled resource of the terminal and the time slot associated with the alternate resource. The alternate resource for the terminal may be scheduled based at least on one of a bandwidth requirement of the terminal, a quality of service requirement of the terminal, an access time of the terminal, an access priority of the terminal, a service contract length of the terminal, and a service cost of the terminal. The scheduled resource of the terminal may be based on a first resource. In this exemplary embodiment, the terminal is rescheduled from the first resource to the alternate resource. The terminal is directed (e.g., by the central controller 18) to acquire the alternate resource at the set of frequencies of the alternate resource at step 115. When the alternate resource has an associated time slot, the terminal is directed to acquire the alternate resource at the set of frequencies and the time slot associated with the alternate resource. In an exemplary embodiment, the alternate resource is a transponder capacity.

In another more specific exemplary embodiment, the communication system comprises one or more transponders and a partitionable transponder capacity, and the resource is based on a transponder capacity. An alternate capacity of a first transponder is determined from the partitionable transponder capacity. The alternate capacity has a set frequencies. The alternate capacity is scheduled for a first terminal based on a scheduled transponder use of the first terminal. The first terminal is directed to acquire the first transponder at the set of frequencies. The partitionable transponder capacity may be determined based on a scheduled transponder use of each of the one or more terminals. In one exemplary embodiment, the alternate capacity has an associated time slot, and the first terminal is directed to acquire the first transponder at the set of frequencies and the time slot associated with the alternate capacity. Additionally, the alternate capacity may have an associated available RF power, and the first terminal may have an RF power requirement. In this case, the alternate capacity is scheduled for the first terminal based on the scheduled transponder use of the first terminal, the available RF power of the alternate capacity, and the RF power requirement of the first terminal. In another exemplary embodiment, the scheduled transponder use of the first terminal is based on a second transponder, and the first terminal is redirected from the second transponder to the first transponder to acquire the first transponder at the set of frequencies.

The communication system 10 or method 100 may be applied to re-assign an operating remote terminal to a preferred satellite based on an assigned working group, assigned serving teleport or hub, link availability, link margin, preferred satellite communications vendor, least cost routing, and the like. A significant cost benefit is achieved using the communication system 10 or method 100 by using spare or idle satellite communication capacity. For example, a flexible subscriber can take advantage of a low cost lease, time of day pricing, as-available spectrum pricing, intermittent regional service, and the like. Terminals may also vacate a preferred channel to allow access by a higher priority user, and left-over capacity may be provided for critical situations (e.g., real-time request for additional or new service).

The invented method and apparatus present significant benefits that would be apparent to one of ordinary skill in the art. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for resource allocation in a wireless communication system having out-of-band communication with one or more terminals, the one or more terminals each having a scheduled resource use in the wireless communication system, the method comprising the steps of:
determining an alternate resource in the wireless communication system from at least one of the scheduled resource uses, the alternate resource having a set of frequencies;
scheduling the alternate resource for one of the terminals based on the scheduled resource use of the terminal; and
directing the terminal to acquire the alternate resource at the set of frequencies.

2. A method for resource allocation according to claim 1, wherein the alternate resource has a time slot, and wherein said directing step comprises directing the terminal to acquire the alternate resource at the set of frequencies and the time slot.

3. A method for resource allocation according to claim 1, wherein the alternate resource has an available radio frequency (RF) power, wherein the terminal has an RF power requirement, and wherein said scheduling step comprises scheduling the alternate resource for the terminal based on the RF power requirement and the available RF power.

4. A method for resource allocation according to claim 1, wherein the alternate resource is a transponder capacity.

5. A method for resource allocation according to claim 1, wherein said scheduling step comprises scheduling the alternate resource for the terminal based at least on one of a bandwidth requirement of the terminal, a quality of service requirement of the terminal, an access time of the terminal, an access priority of the terminal, a service contract length of the terminal, and a service cost of the terminal.

6. A method for resource allocation according to claim 1, wherein the scheduled resource use of the terminal is based on a first resource, and wherein said scheduling step comprises reassigning the terminal from the first resource to the alternate resource.

7. A radio communication system for allocating resources to one or more terminals, the radio communication system comprising:
at least one scheduled resource;
a first terminal selected from the one or more terminals having a resource requirement and configured to acquire an alternate resource in response to an out-of-band signal, said alternate resource having a set of frequencies; and
a controller configured to:
determine said alternate resource from said at least one scheduled resource;
schedule said alternate resource for said first terminal based on said resource requirement; and
direct said first terminal to said alternate resource at said set of frequencies via said out-of-band signal.

8. A radio communication system according to claim 7, wherein said alternate resource has a time slot, and wherein said controller is further configured to schedule said alternate resource for said first terminal based on said set of frequencies and said time slot.

9. A radio communication system according to claim 7, wherein said resource requirement of said first terminal comprises an RF power requirement, wherein said alternate resource has an available RF power, and wherein said controller is further configured to schedule said alternate resource for said first terminal based on said frequency, said RF power requirement, and said available RF power.

10. A radio communication system according to claim 7, wherein said first terminal comprises an out-of-band transceiver configured to:
transmit a signal indicating said resource requirement to said controller; and
receive said out-of-band command from said controller.

11. A radio communication system according to claim 7, wherein said controller comprises an out-of-band transceiver configured to:
receive a signal indicating said resource requirement from said first terminal; and
transmit said out-of-band command to said first terminal.

12. A radio communication system according to claim 7, wherein a second terminal of the one or more terminals has a scheduled resource, and wherein said controller is further configured to determine said alternate resource from said scheduled resource of said second terminal.

13. A radio communication system according to claim 7, wherein said at least one resource comprises at least one transponder capacity.

14. A radio communication system according to claim 7, wherein said resource requirement is based at least on one of a bandwidth requirement of said first terminal, a quality of service requirement of said first terminal, an access time of said first terminal, an access priority of said first terminal, a service contract length of said first terminal, and a service cost of said first terminal.

15. A radio communication system according to claim 7 further comprising one or more satellite transponders providing said at least one scheduled resource; wherein said first terminal comprises an antenna configured to communicate with at least one of said one or more satellite transponders; and wherein said controller is further configured to acquire and transmit to said first terminal at least one of a serving satellite ephemeris, a channel assignment, a schedule assignment, an internet protocol (IP) address, a security key, a communication protocol, and a backhaul parameter.

16. A method for allocating a partitionable transponder capacity in a wireless communication system having one or more terminals and one or more transponders, the method comprising:
determining an alternate capacity of a first transponder of the one or more transponders from the partitionable transponder capacity, the alternate capacity have a set frequencies;
scheduling the alternate capacity for a first terminal of the one or more terminals based on a scheduled transponder use of the first terminal; and
directing the first terminal to acquire the first transponder at the set of frequencies.

17. A method for allocating a partitionable transponder capacity according to claim 16 further comprising determining the partitionable transponder capacity based on a scheduled transponder use for each of the one or more terminals.

18. A method for allocating a partitionable transponder capacity according to claim 16, wherein the alternate capacity has a time slot, and wherein said directing step comprises directing the first terminal to acquire the first transponder at the set of frequencies and the time slot.

19. A method for allocating a partitionable transponder capacity according to claim 16, wherein the scheduled transponder use of the first terminal is based on a second transponder, and wherein said directing step comprises redirecting the first terminal from the second transponder to the first transponder to acquire the first transponder at the set of frequencies.

20. A method for allocating a partitionable transponder capacity according to claim 16, wherein the alternate capacity has an available RF power, wherein the first terminal has an RF power requirement, and wherein said scheduling step comprises scheduling the alternate capacity for the first terminal based on the scheduled transponder use of the first terminal, the available RF power, and the RF power requirement.
